(19) United States
(12) Patent Application Publication
(10) Pub. No.: US 2023/0397595 A1
(43) Pub. Date: Dec. 14, 2023

(54) COMPUTER-IMPLEMENTED METHOD FOR APPLYING A PRODUCT ON AN AGRICULTURAL FIELD

(71) Applicant: BASF AGRO TRADEMARKS GMBH, Ludwigshafen am Rhein (DE)

(72) Inventors: Marcel Enzo GAUER, Köln (DE); Carvin Guenther SCHEEL, Köln (DE); Volker NIGGE, Münster (DE)

(21) Appl. No.: 18/033,503

(22) PCT Filed: Oct. 26, 2021
(86) PCT No.: PCT/EP2021/079741

§ 371 Date: Apr. 24, 2023

(30) Foreign Application Priority Data
Oct. 27, 2020 (EP) 20204167.9

(51) Int. Cl. A01M 7/00; B05B 12/08; B05B 12/12; A01C 23/00; A01G 25/16; A01C 21/00

(52) U.S. Cl. CPC A01M 7/0089; B05B 12/081; B05B 12/126; A01C 23/007; A01G 25/16; A01C 21/005

(57) ABSTRACT

A computer-implemented method for applying a product on an agricultural field, comprising the steps: receiving a control signal to start an adaptation of a product rate and/or of a frequency during a current application of the product on the agricultural field (S10); continuously determining a current amount of the product in a tank of an application device for applying the product based on a treatment savings parameter (S20); continuously determining a current position of the application device in a route through the agricultural field (S30); continuously adapting the product rate and/or the frequency based on the current position of the application device in the route through the agricultural field and the current amount of the product in the tank of the application device such that at the end of the route of the application device through the agricultural field a predetermined amount of the product is in the tank (S40).

### TECHNICAL FIELD

The present disclosure relates to a computer-implemented method for applying a product on an agricultural field, a system for applying a product on an agricultural field, a use of an application device in such a method, a computer program element for such a method, a control device for such a method.

### TECHNICAL BACKGROUND

Agricultural products such as crop protection products, seeds or fertilizer are indispensable in agriculture due to their impact on yield and have a significant impact on environmental aspects. The application of agricultural products on an agricultural field is therefore an important issue in agricultural. Recommendations how to apply the agricultural products vary from theoretical basis in form of written documents to observations in form of human experts. These recommendations result e.g. in application rate maps for the agricultural product, which are used from a farmer for applying the product on the agricultural field. It has been found that a further need exists to assist the famer for applying the agricultural product on the agricultural field.

### SUMMARY OF THE INVENTION

It is an object of the present invention to provide a method for applying an agricultural product on the agricultural field. These and other objects, which become apparent upon reading the following description, are solved by the subject matter of the independent claims. The dependent claims refer to preferred embodiments of the invention.

According to a first aspect of the present disclosure a computer-implemented method for applying a product on an agricultural field is provided, comprising the steps: receiving a control signal to start an adaptation of a product rate and/or of a frequency during a current application of the product on the agricultural field; continuously determining a current amount of the product in a tank of an application device for applying the product; continuously determining a current position of the application device in a route through the agricultural field; continuously adapting the product rate and/or the frequency based on the current position of the application device in the route through the agricultural field and the current amount of the product in the tank of the application device such that at the end of the route of the application device through the agricultural field a predetermined amount of the product is in the tank.

According to a another aspect, a computer-implemented method for providing a treatment savings parameter for an application device in real-time wherein the application device comprises at least one sensor device and at least one treatment component, comprises the steps of providing location-specific sensor data of the agricultural field from the at least one sensor device, analyze the location-specific sensor data with respect to at least one treatment indicator and provide a treatment savings parameter, wherein the treatment savings parameter relates to an amount of treatment based on the location-specific sensor data in relation to an amount of treatment based on a reference treatment. In this way, the real-time data is aggregated with data from a reference treatment and comparison and data processing is facilitated. Further use by the one or other application devices is enhanced.

Reference treatment comprises data from a different treatment, for example data from a flat, i.e. uniform, treatment, historic data from the same agricultural field, data from a nearby agricultural field or from another agricultural field sharing relevant traits.

In a further aspect of the present disclosure, the method comprises additionally the step of generating location-specific control data based on the location-specific sensor data for at least one treatment component. In this way, the aggregated data can be directly used to facilitate the control data generation.

In a further aspect the location-specific control data relates to a location-specific on/off-operation of at least one treatment component. In this way, having a binary option only, data processing and transmission requirements are reduced.

In another aspect the method comprises additionally the step of controlling the at least one treatment component based on the location-specific control data. In this way, the aggregated data can be directly used to facilitate the control of the treatment component.

In another aspect, the amount of treatment based on a reference treatment is not location-specific. In this way, the requirements for the needed data storage and processing means are reduced.

In another aspect, the method comprises additionally the step of displaying the treatment savings parameter on a display unit. In this way, the treatment is facilitated.

In an even further aspect, the method comprises additionally the step of updating the treatment savings parameter in real time. In this way, the treatment is facilitated, allowing for real-time adjustments and reactions.

In another aspect, the treatment savings parameter is stored in a map of the agricultural field, in particular in a location-specific map of the agricultural field. In this way further use for other application devices or later treatments is facilitated.

In another aspect, a computing apparatus is disclosed, especially a distributed computing system, comprising a communication interface for receiving and sending data, the computing apparatus being configured to receive location-specific sensor data via the communication interface, to analyze the location-specific sensor data with respect to at least one treatment indicator and to generate control data and send out the control data via the communication interface.

A treatment indicator can comprise at least one characteristic of the soil, the plant cover, the weather, life forms, cultivation phase, time, the treatment, in particular the type of treatment or the treatment product, and any other agricultural relevant parameter. It is used to determine the type and amount of treatment which should be executed.

In another aspect, a control unit for operating a treatment device for applying a treatment product to an agricultural field is disclosed. The control unit comprises a communication interface for sending and receiving data and the treatment device comprises at least one treatment component, wherein the control unit is configured receive control data and to provide control data to control the at least one treatment component.

In another aspect, a treatment device for applying a treatment product to an agricultural field is disclosed. The treatment device comprises at least one treatment component and at least one sensor device. The treatment device is adapted to perform any of the above methods.

In another aspect, an application device is disclosed. The application device comprises a computing apparatus, a control unit and a treatment device and is adapted to perform any of the above methods.

In another aspect, a computer program or computer readable non-volatile storage medium is disclosed, comprising computer readable instructions, which when loaded and executed by a computing apparatus perform the methods of any of the above methods and/or control the treatment device and/or the application device.

The term product is to be understood broadly in the present case and comprises any product, which can be applied on an agricultural field. Preferably the products may comprise crop protection products, pesticide, fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, fertilizers, seeds, water, etc. The term continuous means in the following a recurring activity (e.g. determining the position and adapting the product rate and/or frequency) along the path, whereby the recurring activity may be repeated e.g. every minute, every 30 s or 10 s or 1s or every 100 meter, 10 meter, 5 meter or 1 meter. The term continuous is the opposite of a singular event or uniquely. The term product relates to any physical state of the product, e.g. fluid, rigid or gaseous. The term agricultural field is to be understood broadly in the present case and comprises an area which is configured to serve as basis for growing of agricultural goods, e.g. wheat and rice. The agricultural field may comprise any shape or size. The agricultural field is not limited to a continuous area. The agricultural field may vary in its biological characteristics. The term control signal is to be understood broadly in the present case and comprises any analog or digital signals. The term product rate is in the present case to be understood as amount of a product per an area. The amount may be expressed in kilogram or liters. The area may be expressed in square meter or hectare. The product rate depends on the product and the characteristics of the agricultural field. For example a part of the agricultural field may comprise lots of weed such that the product rate of a specific pesticide may be accordingly high. The term frequency means in the present case the frequency of an application of an application device. For example, in case of an application of a pesticide on an agricultural field, the pesticide may be applied every time a weed is detected. In this case the detection of the weed may be carried out by sensor, wherein the sensor measures for example a reflected light from the weed. The trigger for applying the pesticide may be based on a comparison of the measured reflected light with a threshold. Hence, a change of the threshold is a possibility to adapt the frequency of applying the pesticide on the agricultural field. The term tank is to be understood broadly in the present case and comprises any element configured to store a product. The term tank preferably comprises in the present case hollow bodies. The term application device is to be understood broadly in the present case and comprises any device configured to apply a product on an agricultural field. Preferably the term application device comprises sower, fertilizer machine and sprayer. The application device may be self-propelled, towed by tractor or mounted on a tractor. The term route means in the present case a path of the agricultural device through the agricultural field. The route may be derived from tramlines in the field. The route may be a random path through the agricultural field (e.g. in case the agricultural field is a lawn). The route preferably comprises information of a length of the route. The agricultural device moves along the route. Based on the position of the application device along the route and an application width of the application device an area already treated by the application device may be determined. Based on the position of the application device in the route and the application width of the application device the remaining area to be treated by the application device may be determined. The predetermined amount of the product which should be in the tank at the end of the route can be defined in different ways, e.g. as an absolute number of the product, as product range with a minimum value and a maximum value, as percentage of the tank volume, as percentage range of the tank volume (e.g. 1 to 10 liters/kilograms; 50 liter/kilograms with a tolerance of +/−5 liters/kilograms; between 1.5 and 10% of the total tank volume; etc.).

The application device may by equipped with one or more treatment devices. The treatment device may be configured to collect field data via treatment components and/or sensor devices. The treatment device may be configured to sense field data of the agricultural field via the sensor device. The treatment device may be configured to treat the agricultural field via the treatment component.

The application device may be equipped with or operatively coupled with different apparatuses, for example a geolocation device, a communication interface, a sensor device, a control unit, a communication device, computing means and the like.

Additionally, the application device may comprise a sensor device for acquiring a measure of the amount of treatment and/or treatment product applied to the agricultural field. Treatment component(s) may be operated based on sensor signals provided by the sensor device(s) of the treatment device. The treatment device may comprise a communication interface and/or unit for connectivity. Via the communication unit the treatment device may be configured to provide, receive or send field data, to provide, send or receive operation data and/or to provide, send or receive control data.

In other words, the invention is based on the knowledge that at the end of the application of the product along the route there is either too much product in the tank of the agricultural device or too little product in the tank of the agricultural device. In case there was too little product in the tank, it was not possible to cover the complete area of the agricultural field with the product. This means that the tank of agricultural device has to be refueled with the product again to apply the remaining area with the product. This is disadvantageous in terms of cost and time and could lead to too little or too much product in the tank. In case there is too much product in the tank at the end of the application, unused amount of the product must be disposed of. This is disadvantageous in terms of disposal costs and time. After receiving a start signal, the disclosed method determines the current amount of product in the tank and the current position of the agricultural device along the route. For example, the route may be provided by a tramline, a driving path and/or an area already covered reveals in combination with a working width of the application device the already treated area of the application device. Based on the length of route still to be covered and the amount of product still in the tank, the method now adapts the product rate and/or the frequency of the application device inside predefined ranges, such that the amount of the product in the tank has a certain value at the end of the route (e.g. zero or 50I as buffer). For example, the application rate and/or frequency can be increased, if the amount of product in the tank is too large such that the tank is empty at the end of the route. This could be advantageous as no time consuming and costly disposal of the product is necessary. For example, the application rate and/or frequency can be lowered in case the amount of product in the tank is too low, so that all areas or plants along the route can be treated without refilling the tank. This could be advantageous as it ensures a complete treatment of the area along the route.

In an embodiment the control signal to start the adaptation of the product rate and/or of the frequency is based on a manual input and/or an automatic input, wherein the automatic input is preferably based on an initial length of the route and the current position of the application device in the route through the agricultural field. The manual input may come from a user, e.g. farmer controlling the agricultural device. The automatic input may be triggered when a certain length of the route is already treated by the application device, preferably 0.5 length of the route, particularly preferred 0.66 length of the route and extremely preferred 0.75 length of the route. The automatic input may be triggered when a certain amount of the area of the agricultural field is already treated, preferably after 50%, particularly preferred after 60% extremely preferred after 75% or 80%. This may be advantageous, as it ensures that the tank may be empty at the end of the route or that the entire area may be treated with the product. The automatic input may be triggered by historical data of previous treatments and data from the current treatment. The automatic input may be triggered based on a machine learning algorithm, wherein the machine learning algorithm may be trained with historical data of previous treatments of the field to be treated.

In an embodiment the method is provided, wherein continuously determining the current amount of the product in the tank of the application device is based on at least one sensor configured to measure the amount of the product in the tank and/or continuously determining the current amount of the product in the tank of the application device is based on a calculation, based on an initial amount of the product in the tank of the application device and an amount of the product already applied on the agricultural field. The sensor may be a weight sensor, a fill level sensor. The sensor may provide continuously measurement values of the amount of the product in the tank to a determining unit via an interface (e.g. Ethernet, Profibus, etc.). This may be advantageous to precisely determine the amount of the product in the tank of the agricultural device. The initial amount of the product in the tank may be provided by a user input of the farmer or may be provided at a filling station when filling the tank. The amount of the product already applied on the agricultural field may be determined by a flow sensor of the application device, wherein the flow sensor measures the amount of the product already applied. The amount of the product already applied may be determined by integrating a distance of the route already covered with the application device and the corresponding application rates and/or frequency, wherein the application rate and/or frequency may be read out from an application rate map. This may be advantageously due to a cost efficient way to determine the amount of the product in the tank, as no additional sensor are required.

In an embodiment the method is provided, wherein continuously determining the current position of the application device in the route through the agricultural field is based on a Global Positioning System of the application device and/or a continuous analysis of a movement speed of the application device on the route through the agricultural field. An integration of the movement speed over a time leads to the current position of the application device in the route through the agricultural field. The Global positioning system may be advantageous to precisely determine the position of the application device. The analysis of the movement speed may be a cost effective alternative to determine the position of the application device, as no additional sensors are required.

In an embodiment the method is provided, wherein the product rate and/or the frequency is adapted within predefined ranges. The predefined ranges may be limited by thresholds, e.g. an upper threshold and a lower threshold, wherein below the lower threshold an application may be useless and above the upper threshold an application may be harmful to the environment. The predefined ranges may comprise more than two thresholds and/or different allowable combinations of thresholds. This may be advantageous to increase an efficiency of applying the product on the agricultural field.

In an embodiment the method is provided, wherein continuously adapting the product rate is further based on an application map of the product for the agricultural field. The term application map of the product comprises in the present case a map comprising product rates along the route. The product rates in the application map may serve as a basis for the adaption, such that product rate may be increased or decreased by e.g. 10% in comparison to the basis. This may be advantageous to reduce a deviation from the initial values of the application map with simultaneous emptying of the tank to the predetermined amount of the product in the tank.

In an embodiment the method is provided, wherein continuously adapting the frequency comprises the step of adapting a triggering threshold value for triggering the application device to apply the product on the agricultural field, in case a sensor signal is used for triggering an application of the product on the agricultural field. Measuring data from the sensor is compared to the triggering threshold value for triggering the application device. In case the measured data is below or above the threshold value the device is triggered to apply the product on the agricultural field or not. By adapting the threshold value the triggering is adapted and therefore the frequency of applying the product on the agricultural field. E.g. by reducing the triggering threshold also smaller accumulations of weed are detected. This may be advantageous for the targeted application of the product on the weed in the agricultural field with simultaneous emptying of the tank to the predetermined amount of the product in the tank. Preferably, based on the amount applied and/or corresponding product rates and/or corresponding frequency and/or triggering thresholds so far along the route, the amount still to be applied along the remaining route is estimated. Preferably based on the estimate and the current amount of the product in the tank and the current position, the product rate and/or the frequency are continuously adapted.

In an embodiment the method is provided, wherein the continuously adapting the product rate and/or the frequency is based on a forecast calculation, which is based on an amount of the product already applied on the route through the agricultural field and the remaining route through the agricultural field. The product already applied on the route may be determined by sensors, e.g. weight sensors. The product already applied may be indicative for a distribution of plants (e.g. weed, oils seed rape). Based on the distribution of plants a forecast calculation of the necessary amount for the remaining route may be derived. The forecast calculation may lead advantageously to a precise emptying of product in conjunction with an efficient treatment of the agricultural field.

In an embodiment the method is provided, wherein the route of the application device is laid out through several physically separated field units. This may be advantageous to increase the efficiency of applying a product on several agricultural fields, as calculation possibilities or the solution space are increased, which may lead to better results./

In an embodiment the method is provided, wherein continuously adapting the product rate and/or the frequency is further based on a predetermined number of tank fillings or on a predetermined total product quantity. This may advantageous for an increased efficiency, as a larger solution space is considered for adapting the product rate and/or the frequency.

In an embodiment the method is provided, wherein the product is a crop protection products, pesticide, fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, fertilizer, seed, water, etc. In an example, the application device is continuously monitored in terms of position, applied amount of product, production rate and/or frequency.

A further aspect of the present disclosure relates to a system for applying a product on an agricultural field, comprising: a receiving unit configured to receive a control signal to start a continuous adaptation of a product rate and/or a frequency during a current application of the product on the agricultural field; a first determining unit configured to continuously determine a current amount of the product in a tank of an application device for applying the product; a second determining unit configured to continuously determine a current position of the application device in a route through the agricultural field; an adapting unit configured to continuously adapt the product rate and/or the frequency based on the current position of the application device in the route through the agricultural field and the current amount of the product in the tank of the application device such that at the end of the route of the application device through the agricultural field a predetermined amount of the product is in the tank. This may be advantageous to increase the efficiency of applying the product on the agricultural field. The receiving unit, the first determining unit, the second determining unit and/or the adapting unit may be separate hardware based CPUs, virtual software units executed one or more hardware CPUs.

A further aspect of the present disclosure relates to a use of an application device in a method described above.

A further aspect of the present disclosure relates to a computer program element configured to carry out steps of the method described above. The computer program element might therefore be stored on a computing unit, which might also be part of an embodiment. This computing unit may be configured to perform or induce performing of the steps of the method described above. Moreover, it may be configured to operate the components of the above described system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure. A further aspect of the present disclosure relates to a control device configured to perform steps of the method described above, and a computer-readable medium which stores the computer program element described above.

### BRIEF DESCRIPTION OF THE DRAWINGS

In the following, the present disclosure is described exemplarily with reference to the enclosed figure, in which

FIG. 1 is a schematic view of a method according to the preferred embodiment of the present disclosure.

FIG. 2 shows a flow chart of the method for providing a treatment savings parameter, according to an embodiment

FIG. 3 shows an embodiment of determining a treatment savings parameter

FIG. 4 shows another embodiment of determining a treatment savings parameter;

FIG. 5 shows an even further embodiment of determining a treatment savings parameter;

FIG. 6 shows an embodiment of a display output of a display, operatively coupled with an application device;

FIG. 7 shows an example of a treatment device, according to an embodiment;

FIG. 8 shows a distributed computing system including an application device, according to an embodiment.

### DETAILED DESCRIPTION OF EMBODIMENT

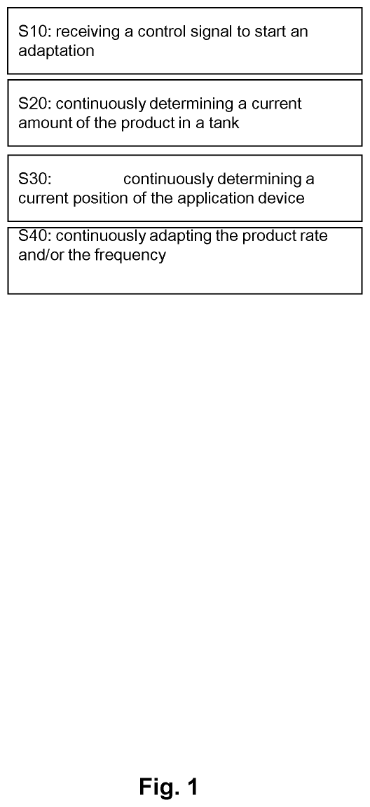

FIG. 1 is a schematic view of a method according to the preferred embodiment of the present disclosure. In the following, an exemplary order of the steps according to the present disclosure is explained. However, the provided order is not mandatory, i.e. all or several steps may be performed in a different order or simultaneously.

The method below can be summarized as follows. The machinery is constantly monitored. Collected information can be product applied per area, position, machinery settings. As soon a start signal is received a current amount of a product in a tank of an application device and a current position of the application device in a route through an agricultural field are continuously determined. Based on the current position, a remaining distance along the route is determined. The remaining distance along the route in combination with the working width of the application device corresponds to the untreated area of the agricultural field. Based on the current amount of product in the tank and the distance remaining along the route or the area still to be treated along the route, the product rate and/or frequency of the application device is adapted such that at the end of the route there is a certain amount of the product in the tank. Preferably, based on the amount applied and/or corresponding product rates and/or corresponding frequency so far along the route, the amount still to be applied along the remaining route is estimated. Preferably based on the estimate and the current amount of the product in the tank and the current position, the product rate and/or the frequency are continuously adapted.

In a first step S10 a control signal to start an adaptation of a product rate and/or of a frequency during a current application of the product on the agricultural field is received by receiving unit. The control signal may be a manual input from a user, e.g. a farmer controlling the agricultural device. The control signal may be an automatic control signal, wherein triggered when a certain length of the route is already treated by the application device, e.g. 0.5 length of the route. The product is in the present case an herbicide for treating weeds. The agricultural field is in the present case a continuous field where corn is grown.

In step S20 a current amount of the product in a tank of an application device for applying the product is continuously determined by a first determination unit based on a treatment savings parameter. In the present example the current amount of the herbicide in the tank of the application device is determined by a fill level sensor applied on the surface of the tank. The application device in the present example is a sprayer mounted on a tractor.

In step S30 a current position of the application device in a route through the agricultural field is continuously determined by a second determination unit. The route through the agricultural field may describe a predefined path of the agricultural device through the agricultural field and a corresponding length. The position is in the present example determined by a Global Positioning System (i.e. GPS) that is arranged at the application device. Hence, it is possible to determine the remaining length of the route or remaining area to be treated. The route may describe a random path of the agricultural device through the agricultural field. Based on the position it may be determined whether the position is already treated by the application device. Based on the current position and a previous position of the agricultural device further a driving direction of the application device may be determined. Based on the driving direction of the application device a position of the sprayer with its corresponding working width may be determined.

In step S40 the product rate and/or the frequency are continuously adapted by a adaption unit based on the current position of the application device in the route through the agricultural field and the current amount of the product in the tank of the application device such that at the end of the route of the application device through the agricultural field a predetermined amount of the product is in the tank. In the present example of weed control the fill level sensor detects to high amount of the herbicides in the tank of the agricultural device. Hence the frequency is increased by adapting a triggering threshold value for triggering the application device to apply the herbicide on the agricultural field, wherein a weed detection sensor signal is used for triggering an application of the herbicide on the agricultural field. Further the product rate of the herbicide is increased. Hence, it is possible to reduce the current amount of the tank at the end of the route to a certain amount of the product in the tank, e.g. zero. Due to possible fluctuations in the distribution of weeds over the agricultural field, from a certain remaining distance/length of the route in this example the frequency and the product rate are increased to the maximum values (i.e. a so called flat rate mode respectively higher product rate per area; e.g. in the flat rate mode it is possible to increase the frequency to a continuous output of the product and to a higher or maximum output value) to ensure complete emptying of the tank. The maximum values are predefined values for the herbicide and the corn on the agricultural field (i.e. product rate that leads to a damage of corn and/or soil and/or environment).

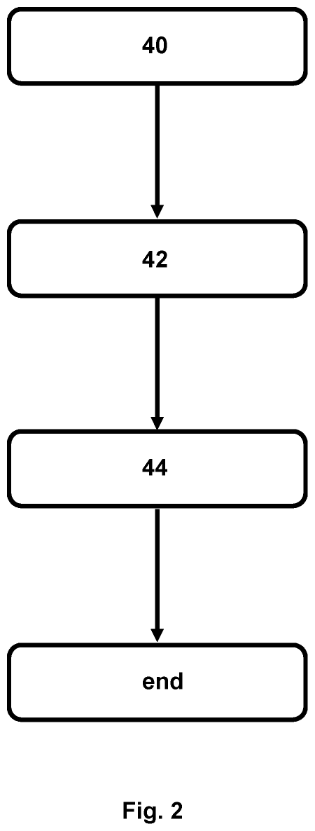

FIG. 2 shows a flow chart of a method for providing a treatment savings parameter, according to an embodiment. In a first step 40, location-specific sensor data from a sensor device acquired in real-time may be provided to a computing means.

The computing means may be completely or partly a part of the application device 10, or a distributed computing system and may comprise mobile devices communicatively coupled to the computing means.

In a second step 42, the location-specific sensor data may be analyzed with respect to at least one treatment indicator by the computing means.

In a third step 44, a treatment savings parameter for the treatment is provided. The treatment savings parameter characterizes the amount of treatment based on the location-specific sensor data in relation to an amount of treatment based on a reference treatment.

The treatment savings parameter can be advantageously used to support adapting product rate and/or the frequency based on the current position of the application device in the route through the agricultural field and the current amount of the product in the tank of the application device such that at the end of the route of the application device through the agricultural field a predetermined amount of the product is in the tank, preferably the predetermined amount at the end of the route is substantially zero. In particular it can be used to support the forecast calculation.

In one example, the treatment savings parameter is a comparison between a determined amount of treatment and a flat rate treatment, wherein the same amount of treatment is applied on the agricultural field. Additionally or alternatively, the reference treatment can also comprise historic data, in particular data from historic treatments.

In one exemplary embodiment, a comparison between the location-specific sensor data and a threshold is used to determine if the treatment component should be activated, for example switched between an on- and off-state. Alternatively or additionally, the strength of the activation and therefore the locally applied dosage can be controlled.

As an example, the number or density of weed present in the specific location of the agricultural field can be used. Alternatively or additionally, the number or density of cultivated crops present in the specific location of the agricultural field can be used. The threshold may be determined before the treatment based on previous available data and it may be adapted during the treatment.

The treatment savings parameter for a treatment can be defined in several ways, depending on the available data. The treatment savings parameter is a relation between data derived from in real-time acquired location-specific sensor data and reference treatment data.

In one exemplary embodiment, the treatment savings parameter can relate to a derived amount of treatment which is not to be applied, and the reference data can relate to the amount of treatment used during a flat rate treatment.

In another exemplary embodiment, the treatment savings parameter can relate to the not applied amount of treatment and the reference data can relate to the amount of treatment used during a flat rate treatment.

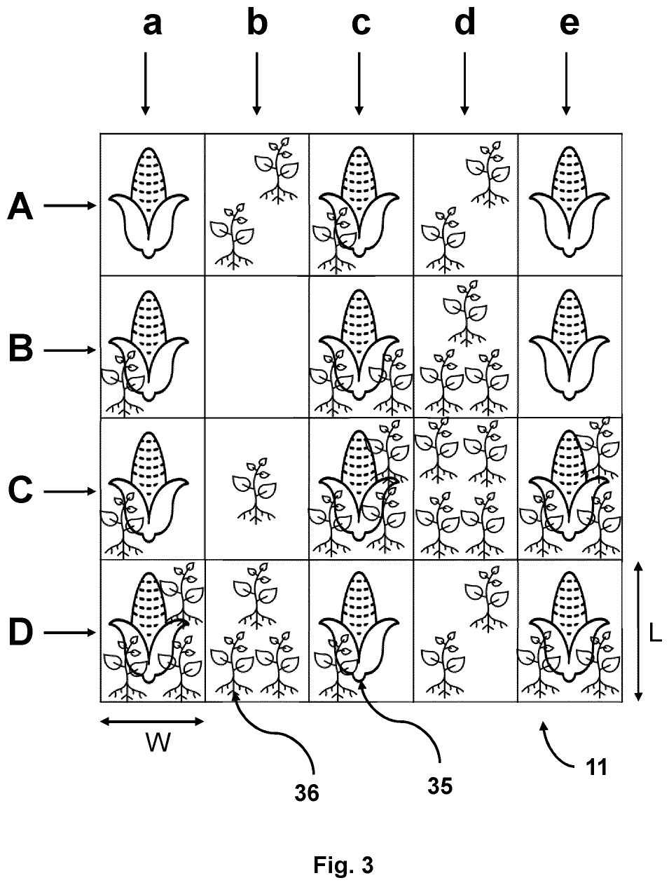

In FIGS. 3 to 5 a part of an agricultural field 11 is depicted, which is divided into subareas. The rows of the subareas are here labeled by capital letters A-D. A′-D′ and A″-D″, and the columns by small letters a-e, a′-e′ and a″-e″, such that a specific subarea can then be addressed by its row and column letter. The agricultural field 11 comprises exemplarily crop plants 35 and weed plants 36. The number of weed plants exemplarily depicts an amount of weed present in the subarea, such that a subarea with two weed plants 35 has a higher amount of weed than a subarea with just one weed plant 36. The depicted crop plants 35 exemplarily depicts the presence of crops. The subareas of the agricultural field 11 are divided based on the working parameters of an application device. The application device has a number of treatment components with a working width W and a working length L. The sensor device of each treatment component acquires location-specific data for each subarea in real-time and the treatment is performed based on it.

In the embodiment depicted in FIG. 3, the treatment performed is spraying a herbicide to counter weed plants 36. The application device for spraying is an agricultural sprayer comprising a treatment component in form of a nozzle and a camera device as sensor device. Historic treatment data about spraying a herbicide to counter the weed plants 36 is present, for example in a remote database or a local storage device. In this example the treatment indicator is the presence of weed 36. The spraying is performed if the amount of weed 36 detected on the subareas is above a certain threshold. For example, the treatment component can be activated if the number of weed plants 36 present in a subarea is above two.

Therefore treatment is performed in this example on the subareas Da, Db, Cc, Bd, Cd and Ce. No treatment is performed on the subareas Aa-Ca, Ab-Cb, Ac, Bc, Dc, Ad, Dd, Ae, Be and De. From the historic treatment data it is derived that treatment was done on all subareas, a flat treatment.

The treatment savings parameter can then be determined based on the number of non-treated subareas divided by the number of treated subareas derived from the historic treatment data in real-time. To illustrate the method, treatment is performed from rows D to A and over all columns a to e at the same time. So the treatment savings parameter could start to amount from 3/5=60% after treating row D, to 5/10=50% after treating rows D and C, to 9/15=60% after treating rows D to B and to 14/20=70% after treating rows D to A. Alternatively or additionally to an accumulated treatment savings parameter, a treatment savings parameter for each row can be determined in real-time. The treatment savings parameter for row D would be 3/5=60%, for row C 2/5=40%, for row B 4/5=80% and for row A 5/5=100%.

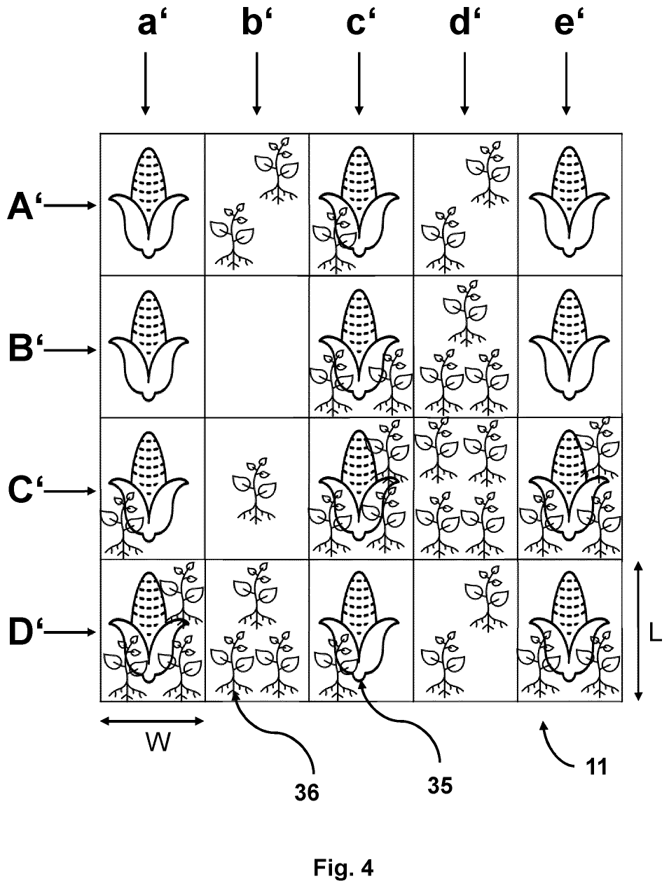

In the embodiment depicted in FIG. 4, the treatment performed is also spraying a herbicide to counter the weed plants 36. In this example a first treatment indicator is the presence of crop 35 and a second treatment indicator is the presence of weed 36. The spraying is performed if the amount of weed 36 detected on the subareas without crop 35 is above a first threshold and if the amount of weed 36 detected on the subareas with crop 35 is above a second threshold. For example, the treatment component can be activated if the number of weed plants 36 is above two and the no crop 35 is present and if the number of weed plants 36 is above one when crop is present.

The treatment savings parameter can then be determined for example based on the number of treatment component activations and the number of possible operations or the number of subareas, in particular from a log file generated by the application device and updated when activating, not activating and/or blocking the one or more treatment components of the application device. In this example the treatment savings parameter for row D′ could be derived in real time to 1-3/5=40%, for row C′ 1-3/5=40%, for row B′ 1-2/5=60% and for row A′ 1-5/5=100%. An accumulated treatment savings parameter for a treatment starting from row D′ to row A′ could the be derived to be 1-3/5=40% after treating row D′, 1-6/10=40% after treating rows D′ and C′, 1-8/15=46.67% after treating rows D′ to B′ and 1-13/20=70% after treating rows D′ to A′.

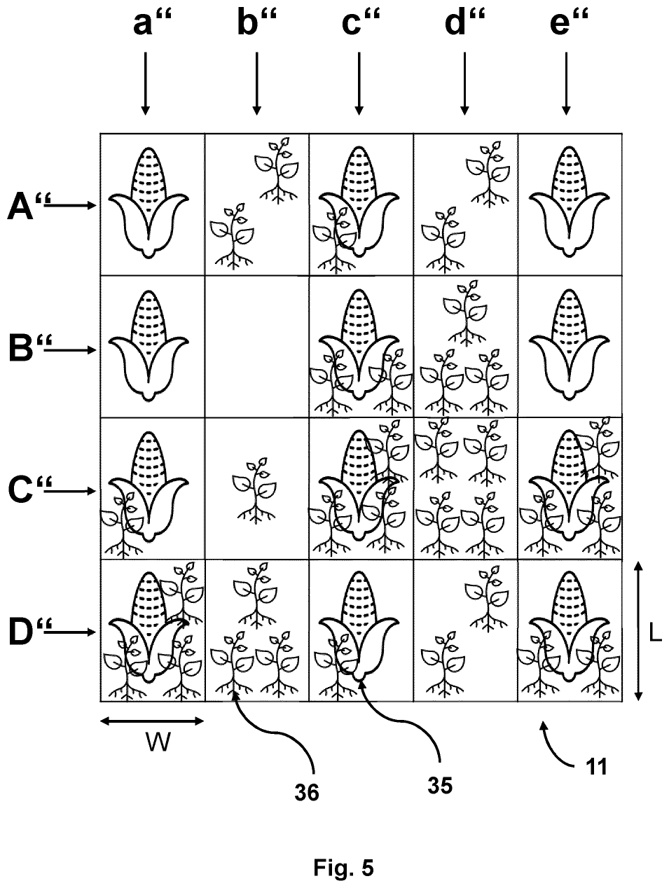

In the embodiment depicted in FIG. 5, the treatment performed is also spraying a herbicide to counter the weed plants 36. In this example a first treatment indicator is the presence of crop 35 and a second treatment indicator is the presence of weed 36. The amount of spraying is here performed in a substantially continuous way based on the detected amount of weed 36. Although here the amount of weed is depicted in a stepwise manner, ranging from one to four weed plants 36, the detected amount of weed can be determined in a continuous way, for example based on a detected biomass. Herbicide can then be sprayed proportional to the detected biomass. Here, for example, the treatment component can be activated to spray a variable dosage of herbicide based on the amount of detected weed 36. In this example, a dosage of 25% is applied if the number of weed plants 36 in a subarea is one, a dosage of 50% is applied if the number of weed plants 36 in a subarea is two, a dosage of 75% is applied if the number of weed plants 36 in a subarea is three and a dosage of 100% is applied if the number of weed plants 36 in a subarea is four or higher.

In this example the treatment savings parameter for row D″ could be derived in real time to 1-(75%+75%+25%+50%+50%)/5=45%, for row C″ 1-(25%+25%+75%+100%+75%)/5=40%, for B″ 1-(0%+0%+50%+75%+0%)/5=75% and for A″ 1-(0%+50%+25%+50%+0%)/5=75%. An accumulated treatment savings parameter for a treatment starting from row D″ to row A″ could then be derived to be 45% after treating row D″, 42.5% after treating rows D″ and C″, 53.3% after treating rows D″ to B″ and 58.75% after treating rows D″ to A″.

In general, treatment savings parameter can alternatively or additionally be based on data from at least one of the following:
status information of at least one treatment component,
position information of at least one treatment component,
area information of an area treated by at least one treatment component,
area information of area to be treated by at least one treatment component,
a location-specific on/off-operation of at least one treatment component,
on the number of off-operations of at least one treatment component,
on the number of on-operations of at least one treatment component,
on the duration of off-operations of at least one treatment component,
on the duration of on-operations of at least one treatment component,
an aggregation for different positions on the agricultural field during operation of at least one treatment component,
reference information based on at least one of the following:
   a non-location-specific application of the treatment,
   a non-location-specific application of at least one treatment component,
   a non-location-specific application per treatment component,
   a non-location-specific application per position information.

Additionally or alternatively, historic data can be used to compare the real-time treatment with a historic treatment or data from a treatment of another agricultural field can be used to compare with the actual treatment.

Data used for the treatment savings parameter can come from the processed real-time location-specific sensor data, such as from a determined location-specific amount of treatment or from control data, but also for example from machine data, external sources, such as external databases, or from other sensor devices, for example a tank sensor.

In a further embodiment the treatment savings parameter is stored on a storage device. This way applied maps can be recorded by storing the time, treatment savings parameter corresponding to such time, the position corresponding to such time and optionally the activation signal information coming from control data corresponding to such time. As a result, the data collected during operation can be stored and used after operation for further analysis.

Here the real or determined treatment may be recorded optionally together with the activation signal including the information on which treatment component was triggered when with which activation signal. In this way the treatment savings parameter can be provided for further use, for example for another treatment, another type of treatment or another application device as input for a treatment.

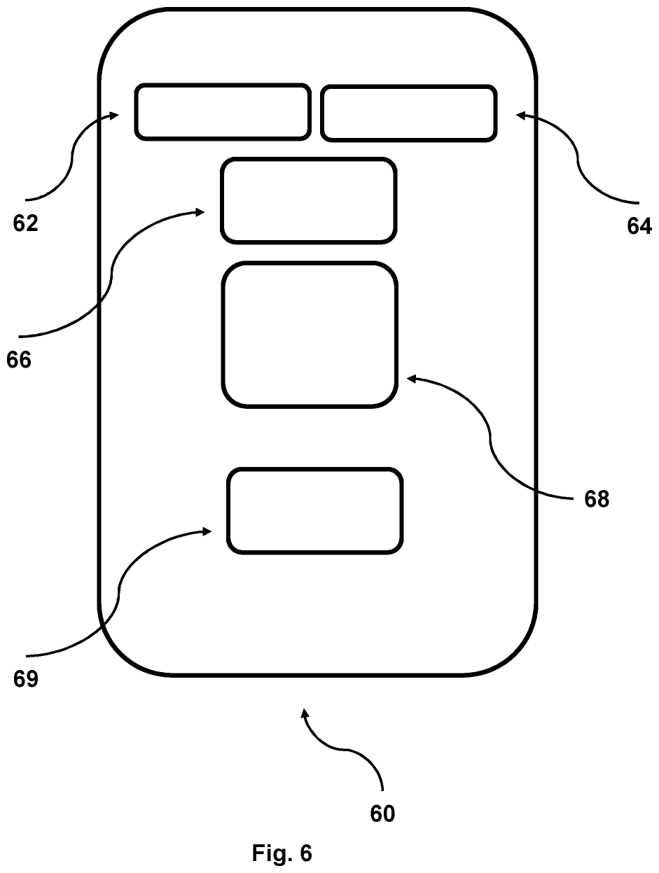

FIG. 6 depicts exemplarily a display output of a display, operatively coupled with an application device performing the methods provided above. On display 60 information is provided:
about the agricultural field 62,
about at least one treatment indicator 64,
about the progress of the treatment 66,
the treatment savings parameter 68 in real time and/or accumulated, and
about the forecast of the product and/or tank fill 69

The displayed information may be updated in real-time or at a specific frequency, for example 1 Hz. Exemplarily, the treatment savings parameter 68 can be updated based on the provided treatment savings parameter or the information about the agricultural field 62 based on location data.

Additionally, the display output may be modified based on external input, especially on input from a human-machine interface, for example from an operator of the application device. For example, a treatment indicator or other performance parameter may be modified based on external input.

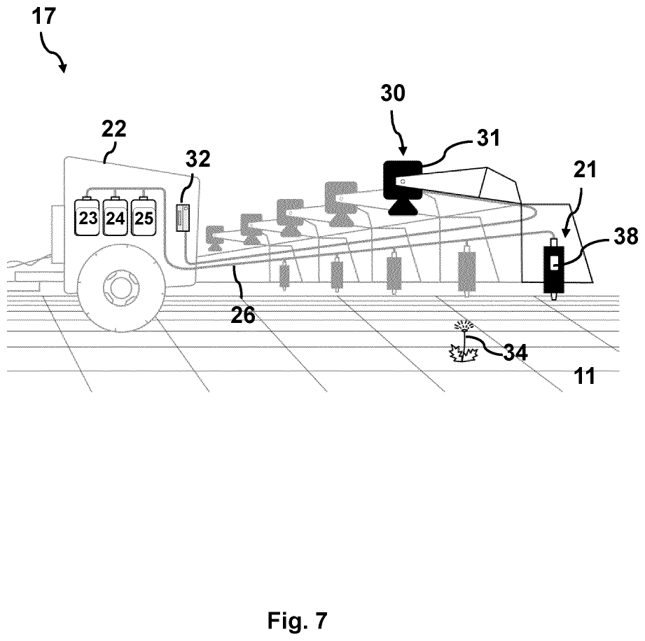

FIG. 7 shows an example of the treatment device 17. It is noted that FIG. 7 is merely a schematic, illustrating main components, wherein the treatment device 17 may comprise more or less components than actually shown. In particular, the treatment device 17, e.g. its fluidic set up as shown, may comprise more components, such as dosing or feed pumps, mixing units, buffer tanks or volumes, distributed line feeds from multiple tanks, back flow, cyclic recovery or cleaning arrangements, different types of valves like check valves, ½ or ⅔ way valves and so on. Also different fluidic set ups and mixing arrangements may be chosen. The present disclosure is, however, applicable to all fluidic setups.

The treatment device 17 shown in FIG. 7 is part of the application device for applying the treatment product on the agricultural field 11 or on one or more subareas thereof. The treatment device 17 may be releasably attached or directly mounted to the application device. In at least some embodiments, the treatment device 17 comprises a boom with multiple treatment components 21, here spray nozzles 21 arranged along the boom of the treatment device 17.

The spray nozzles 21 may be fixed or may be attached movable along the boom in regular or irregular intervals. Each spray nozzle 21 may arranged together with one or more, preferably separately, controllable valves 38 regulate fluid release from the spray nozzles 21 to the agricultural field 11.

One or more tank(s) 23, 24, 25 are in fluid communication with the nozzles 21 through one or more fluidic lines 26, which distribute the one or more treatment products as released from the tanks 23, 24, 25 to the spray nozzles 21. This may include chemically active or inactive ingredients like a treatment product or mixture, individual ingredients of a treatment product or mixture, a selective treatment product for specific weeds, a fungicide, a fungicide or mixture, ingredients of a fungicide mixture, ingredients of a plant growth regulator or mixture, a plant growth regulator, water, oil, or any other treatment product. Each tank 23, 24, 25 may further comprise a controllable valve (not shown) to regulate fluid release from the tank 23, 24, 25 to fluid lines 26. Such arrangement allows to control the treatment product or mixture released to the agricultural field 11 in a targeted manner depending on the conditions determined for the agricultural field 11.

For monitoring and/or detecting, the application device and/or the treatment device 17 may comprise a sensor system 30 with sensor devices 31 arranged along e.g. the boom. The sensor devices 31 may be arranged fixed or movable along the boom in regular or irregular intervals. The sensor devices 31 are configured to sense one or more conditions of the agricultural field, for example plants 34 or insects. The sensor devices 31 may be an optical sensor device 31 providing an image of the field. Suitable optical sensor devices 31 are multispectral cameras, stereo cameras, IR cameras, CCD cameras, hyperspectral cameras, ultrasonic or LIDAR (light detection and ranging system) cameras. Alternatively or additionally, the sensor devices 31 comprise further sensors to measure humidity, light, temperature, wind or any other suitable condition on the agricultural field 11.

In at least some embodiments, the sensor devices 31 may be arranged perpendicular to the movement direction of the treatment device 17 and in front of the nozzles 21 (seen from drive direction). In the embodiment shown in FIG. 7, the sensor devices 31 are optical sensor devices and each sensor device 31 is associated with a single nozzle 21 such that the field of view comprises or at least overlaps with the spray profile of the respective nozzle 21 on the field once the nozzle reach the respective position. In other arrangements each sensor device 31 may be associated with more than one nozzle 21 or more than one sensor device 31 may be associated with each nozzle 21.

The sensor devices 31, the tank valves and/or the nozzle valves 38 are communicatively coupled to a control unit 32. In the embodiment shown in FIG. 3, the control unit 32 is located in a main treatment device housing 22 and wired to the respective components. In another embodiment sensor devices 31, the tank valves or the nozzle valves 38 may be wirelessly connected to the control unit 32. In yet another embodiment more than one control unit 32 may be distributed in the treatment device housing 22 or the application device and communicatively coupled to sensor devices 31, the tank valves or the nozzle valves 38. The control unit 32 may be configured to control and/or monitor the sensor devices 31, the tank valves or the nozzle valves 38 based on control data a control file, a parameter set and/or following a control protocol. In this respect, the control unit 32 may comprise multiple electronic modules. One module for instance may control the sensor devices 31 to collect data such as an image of the agricultural field 11. A further module may analyse the collected data such as the image to derive parameters for the tank or nozzle valve control. Yet further module(s) may control the tank valves and/or nozzle valves 38 based on such derived parameters.

In an exemplary embodiment, the sensor device may comprise a fluid sensor operatively coupled with the fluidic lines 26. Additionally or alternatively, the sensor device may alternatively or additionally comprise a tank sensor for a tank of the application device.

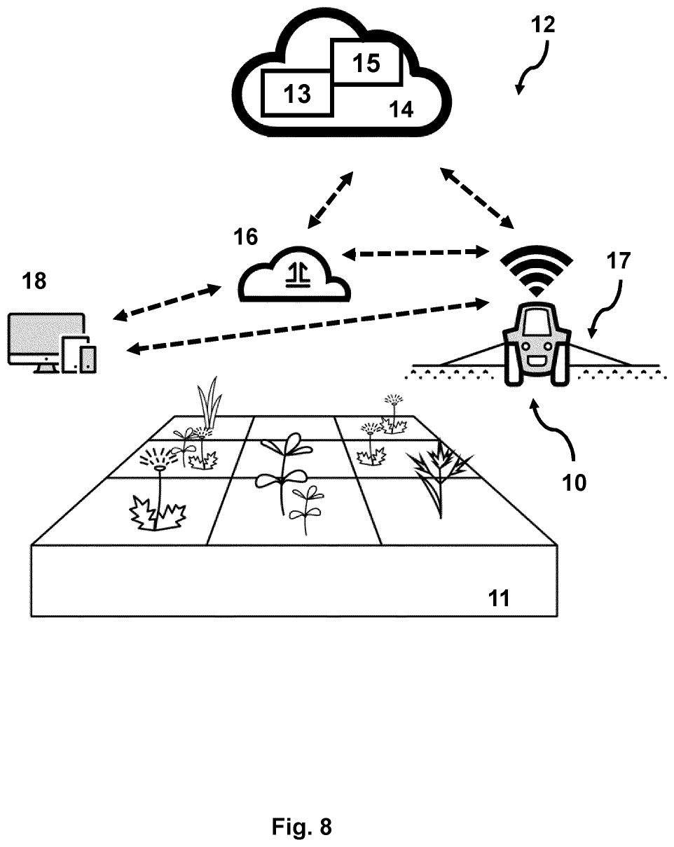

FIG. 8 shows a general overview of a system 12 that is configured for treatment on or at an agricultural field 11, at or on which e.g. crops are to be cultivated. The agricultural field 11 may to be treated by use of a treatment product, which may also be referred to as an agrochemical, e.g. an herbicide, pesticide, insecticide, fungicide, or the like. Further, the agricultural field 11, may be any plant or crop cultivation field, such as a field, a greenhouse, or the like, at a geo-referenced location. As indicated in FIG. 2 by interlines, the agricultural field 11 may optionally be divided into two or more subareas.

The system 12 may comprise or form a distributed computing environment. It may comprise one or more of an application device 10, a first computing resource or means 14, a second computing resource or means 16, and a third computing resource or means 18. The application device 10 and/or the first, second and third computing means 14, 16, 18, may at least partly be remote to each other. At least some of the application device 10 and the first, the second and the third computing means 14, 16, 18 may comprise one or more of a data processing unit, a memory, a data interface, a communication interface, etc. Within the system 12, the application device 10 and the first, the second and the third computing means 14, 16, 18 may be configured to communicate with each other via communication means, such as a communications network, as indicated in FIG. 2 by dashed lines between the entities 10, 14, 16, 18. The application device may also be referred to as a smart farming machinery. The application device 10 may be e.g. a vehicle, such as a tractor or the like, an aircraft, a robot, a smart sprayer, or the like, and may be configured to be operated, for example, computer-aided, by a remote control and/or at least semi-autonomous. The application device 10 may, for example, comprise and/or carry a treatment device 17, which may be e.g. a spraying device for application of a treatment product as described above.

The first computing means 14 may be a data management system configured to send data to the application device 10 and/or to receive data from application device 10. For example, the data received from the application device 10 may comprise one or maps, such as a growth distribution map, a weed distribution map, or the like, which may be generated and/or provided based on data recorded during operation of the application device 10 and/or application of the treatment product at or on the agricultural field 11.

The second computing means 16 may be a field management system configured to generate and/or provide a control parameter set, which may comprise one or more of control data for operating the application device 10, a control protocol, an activation code, a set of threshold adjustments or a basic threshold, a decision logic to the application device 10, and/or to receive data from the application device 10. Such data may also be provided and/or received through the first computing means 14. The third computing means 18 may be a client computer configured to receive client data from and/or to provide data to at least the second computing means 16 and/or the application device 10. Such client data may, for example, comprise an application schedule for the treatment product to be applied on a specific agricultural area by operating the application device 10.

Additionally or alternatively, the client data may comprise field analysis data to provide insights into the health state, weed information, plant or crop information, geo-location data, or the like, of a specific agricultural area.

Further, when data is monitored, collected and/or recorded by the application device 10, such data may be distributed to one or more of, or even to every, computing means 14, 16, 18 of the distributed computing environments.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular the steps S10 to S40 can be performed in any order, i.e. the present invention is not limited to a specific order of these steps. Moreover, it is also not required that the different steps are performed at a certain place or at one place, i.e. each of the steps may be performed at a different place using different equipment/data processing units. As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing means to perform the respective action. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for applying a product on an agricultural field, the method comprising:
receiving a control signal to start an adaptation of a product rate and/or of a frequency during a current application of the product on the agricultural field (S10);
continuously determining a current amount of the product in a tank of an application device for applying the product based on a treatment savings parameter (S20);
continuously determining a current position of the application device in a route through the agricultural field (S30); and
continuously adapting the product rate and/or the frequency based on the current position of the application device in the route through the agricultural field and the current amount of the product in the tank of the application device such that at the end of the route of the application device through the agricultural field a predetermined amount of the product is in the tank (S40).

2. The method according to claim 1, wherein the control signal to start the adaptation of the product rate and/or of the frequency is based on a manual input and/or an automatic input, wherein the automatic input is preferably based on an initial length of the route and the current position of the application device in the route through the agricultural field.

3. The method according to claim 1, wherein continuously determining the current amount of the product in the tank of the application device is based on at least one sensor configured to measure the amount of the product in the tank and/or continuously determining the current amount of the product in the tank of the application device is based on a calculation, based on an initial amount of the product in the tank of the application device and an amount of the product already applied on the agricultural field.

4. The method according to claim 1, wherein continuously determining the current position of the application device in the route through the agricultural field is based on a Global Positioning System of the application device and/or a continuous analysis of a movement speed of the application device on the route through the agricultural field.

5. The method according to claim 1, wherein the product rate and/or the frequency is adapted within predefined ranges.

6. The method according to claim 1, wherein continuously adapting the product rate is further based on an application map of the product for the agricultural field.

7. The method according to claim 1, wherein continuously adapting the frequency comprises the step of adapting a triggering threshold value for triggering the application device to apply the product on the agricultural field, in case a sensor signal is used for triggering an application of the product on the agricultural field.

8. The method according to claim 1, wherein the continuously adapting the product rate and/or the frequency is based on a forecast calculation, which is based on an amount of the product already applied on the route through the agricultural field and the remaining route through the agricultural field.

9. The method according to claim 1, wherein the route of the application device is laid out through several physically separated field units.

10. The method according to claim 1, wherein continuously adapting the product rate and/or the frequency is further based on a predetermined number of tank fillings or on a predetermined total product quantity.

11. The method according to claim 1, wherein the product is a crop protection product, pesticide, fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, fertilizer, seeds and/or water.

12. A system for applying a product on an agricultural field, the system comprising:
a receiving unit configured to receive a control signal to start a continuous adaptation of a product rate and/or a frequency during a current application of the product on the agricultural field;
a first determination unit configured to continuously determine a current amount of the product in a tank of an application device for applying the product;
a second determining unit configured to continuously determine a current position of the application device in a route through the agricultural field; and
an adapting unit configured to continuously adapt the product rate and/or the frequency based on the current position of the application device in the route through the agricultural field and the current amount of the product in the tank of the application device such that at the end of the route of the application device through the agricultural field a predetermined amount of the product is in the tank.

13. Use of an application device in a method according to claim 1.

14. (canceled)

15. (canceled)

16. A non-transitory computer-readable medium having instructions encoded thereon that, when executed by a processing device, cause the processing device to perform the method of claim 1.
